(19) United States
(12) Patent Application Publication
(10) Pub. No.: US 2003/0009750 A1
(43) Pub. Date: Jan. 9, 2003

(54) Optimizing an executable computer program having linkage functions

(76) Inventors: Robert Hundt, Sunnyvale, CA (US); Vinodha Ramasamy, Campbell, CA (US)

Correspondence Address: HEWLETT-PACKARD COMPANY, Intellectual Property Administration, P.O. Box 272400, Fort Collins, CO, 80527-2400, US

(21) Appl. No.: 09/901,363

(22) Filed: Jul. 9, 2001

(51) Int. Cl. G06F 9/45

(52) U.S. Cl. 717/154

(57) ABSTRACT

Method and apparatus for optimizing executable program code having linkage stub code segments. A linkage stub code segment has a symbolic name that is a variation of the symbolic name for the code that implements the function and is used to transfer control to the code that implements the function. A program includes one or more branch instructions that target the linkage stub code segment. To improve performance, the branch instructions that target the linkage stub code segments are identified, and the target addresses in the branch instructions are replaced with the address of the code that implements the function.

The present invention generally relates to dynamic optimization of an executable computer program, and more particularly to dynamic optimization of a program having at least one function with multiple names and code segments associated with the names for transferring control to a code segment that implements the function.

### BACKGROUND

Software application developers rely on software libraries to reduce the time required to develop applications. A library typically includes a number of functions that are available for use in combination with an application. For example, MLIB is a library of mathematical functions available from Hewlett Packard Company. MLIB includes thousands of functions written in several languages, for example, FORTRAN, C, and Assembly. References to library functions by an application program are referred to as “external” function calls.

Certain compilers add underscores to names of external functions referenced in an application program. For example, some FORTRAN compilers add underscores to function calls in the application program in order to avoid conflict with FORTRAN “COMMON” blocks. In order for the functions in a library to be accessible to an application program compiled as such, the library must include entry points for the different function names. For example, if a certain library includes a function foo( ) and the function is referenced as foo( ) in an application program, the compiler changes the call from foo( ) to foo_( ). In this document, foo_( ) is said to be a “linkage stub function” of foo( ). In order to initiate foo( ) in the library from a call to foo_( ) in the application program, the library includes a code segment that is executed when foo_( ) is called. The code segment simply branches to the code for foo( ). It will be appreciated that an underscore is prepended or appended to a function call depending on the implementation. Prepending and appending underscores are two example implementations. It will be appreciated that other naming schemes are possible.

The linkage stub functions introduce instructions into the program flow that are essentially “overhead” in terms of accomplishing the desired function. That is, the instructions in a linkage stub function perform processing that is associated with but not essential to achieving the function. If a particular application references an external function via a linkage stub function, and the function is invoked many times during program execution, for example, as part of a program loop, then a significant amount of time is spent executing the linkage stub function. Thus, execution of linkage stub functions may be viewed as wasted processor time.

A method and apparatus that address the aforementioned problems, as well as other related problems, are therefore desirable.

### SUMMARY OF THE INVENTION

The invention provides a method and apparatus for optimizing executable program code having linkage stub code segments in various embodiments. A linkage stub code segment has a symbolic name that is a variation of the symbolic name for the code that implements the function and is used to transfer control to the code that implements the function. A program includes one or more branch instructions that target the linkage stub code segment. To improve performance, the branch instructions that target the linkage stub code segments are identified, and the target addresses in the branch instructions are replaced with the address of the code that implements the function.

It will be appreciated that various other embodiments are set forth in the Detailed Description and Claims which follow.

### BRIEF DESCRIPTION OF THE DRAWINGS

Various aspects and advantages of the invention will become apparent upon review of the following detailed description and upon reference to the drawings in which:

FIG. 1A is a block diagram that illustrates executable program code that includes example linkage stub functions associated with an example function, foo( );

FIG. 1B is a block diagram that illustrates the example executable program code of FIG. 1A after having undergone dynamic optimization to eliminate calls to linkage stub functions;

FIG. 2 is a flowchart of a process for dynamic optimization of executable program code having linkage stub functions in accordance with one embodiment of the invention; and

FIG. 3 is a flowchart of a process for eliminating linkage stubs in accordance with another embodiment of the invention.

### DETAILED DESCRIPTION

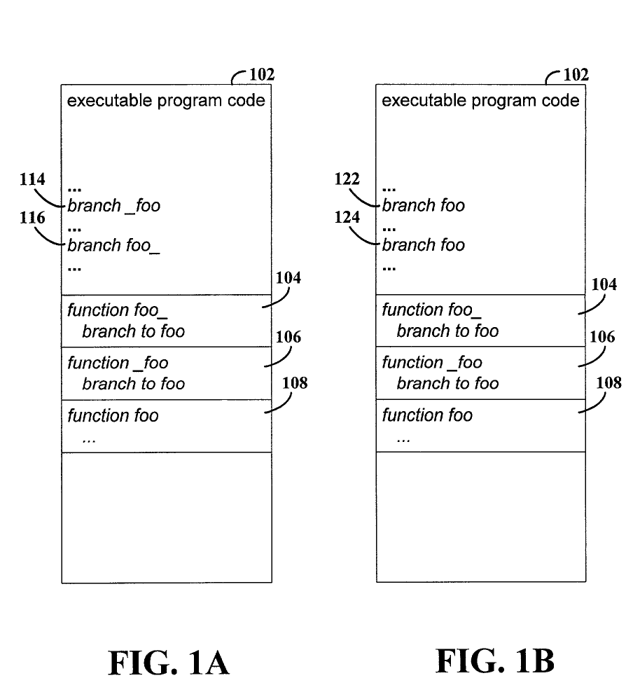

FIG. 1A is a block diagram that illustrates executable program code that includes example linkage stub functions associated with an example function, foo( ). Executable program code 102 includes linkage stub functions 104 and 106 that branch to the executable code for the functionfoo 108. Linkage stub function 104 is named foo_, and linkage stub function 106 is named _foo. The single function of the linkage stub functions is to branch to the code 108 for foo.

For illustration purposes, executable program code 102 also includes calls to the functionfoo via both of the linkage stub functions 104 and 106 as illustrated by branch instructions 114 and 116. In addition, the branch instructions 114 and 116 illustrate the symbolic names of the linkage stub functions instead of branch target addresses. Branch instruction 114 branches to _foo, and branch instruction 116 branches to foo_.

FIG. 1B is a block diagram that illustrates the example executable program code of FIG. 1A after having undergone dynamic optimization to eliminate calls to linkage stub functions. The linkage stub functions 104 and 106 remain unchanged, as does the function foo 108. However, the branch instructions 114 and 116 of FIG. 1A have been changed from branch foo to branch foo and from branch foo_ to branch foo, as is respectively shown with instructions 122 and 124. By eliminating the path through the linkage stub functions, the performance of the executable program code is improved.

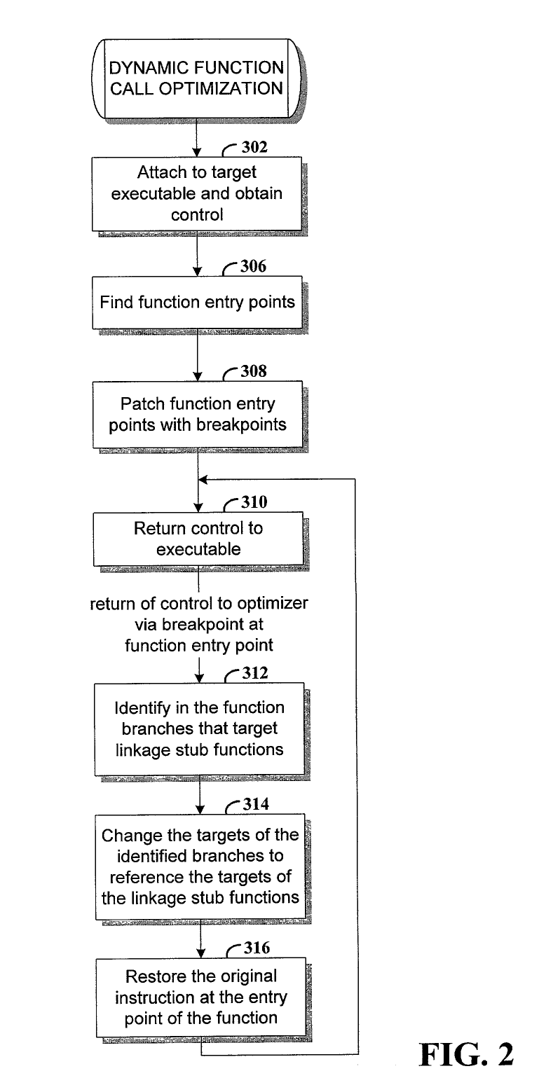

FIG. 2 is a flowchart of a process for dynamic optimization of executable program code having linkage stub functions in accordance with one embodiment of the invention. At step 302, an optimizer process attaches to a target executable program and obtains control. In one embodiment the optimizer process is part of an instrumentation tool.

At step 306, entry points of the functions in the executable application are located. In various embodiments, the present invention uses compiler-generated checkpoints to identify function entry points and endpoints in executable program code. The function entry points and end-points are then used to support analysis of the executable program code. Compiler-generated checkpointing is described in the patent/application entitled, “COMPILER-BASED CHECKPOINTING FOR SUPPORT OF ERROR RECOVERY”, by Thompson et al., filed on Oct. 31, 2000, and having patent/application Ser. No. 09/702,590, the contents of which are incorporated herein by reference.

Each of the function entry points is patched with a breakpoint at step 308. The instructions at the function entry points are saved in a table (not shown) so that they can be restored at the appropriate time. At step 310, control is returned to the executable program. When a breakpoint is encountered at a function entry point in the executable program, control is returned to the optimizer process.

At step 312, branch instructions are identified in the breakpointed function which target linkage stub functions. In one embodiment, the branch instructions are identified by analysis of IP-relative branch instructions in the function. IP-relative branch instructions contain an offset relative to the address of the current instruction. Since during execution of an instruction, the current instruction pointer (IP) points to the current instruction, this offset is enough to perform an IP-relative branch. For the analysis, the offset is extracted from the instruction. The instruction(s) or bundle at the target of the IP-relative branch is analyzed. If the instruction(s) only contain a direct branch to another function (e.g. from foo_ to foo), a linkage stub is identified. IP-relative branch instructions are part of the instruction set of Hewlett Packard's 64-bit machines, and comparable instructions are implemented in other instruction sets.

In another embodiment, procedure lookup tables (PLTs) that are associated with the dynamic load modules are analyzed for linkage stub functions. Procedure Lookup Tables (PLTs) are arrays of function pointers that are filled from the dynamic loader after loading of a dynamic load module. PLTs are used for the following reason. When a function foo( ) calls a function bar( ), which is in a different load module the location of bar( ) is unknown to both the compiler and the linker until the program containing foo( ) is loaded and the program loads the dynamic load module that contains bar( ). During the dynamic loading, the final address of bar( ) is determined by the dynamic loader and depends on where the dynamic load module is loaded in memory. Different instances of the program containing foo( ) might see a bar( ) located at different addresses. PLTs are function pointer tables that get filled by the dynamic loader after loading of load modules. Relative to the present invention, the PLTs are scanned and target addresses are matched with entries in the symbol table to identify the underscore stubs.

At step 314, each branch instructions identified as targeting a linkage stub function is modified to target the function referenced by the linkage stub function. At step 316, the original instruction at the entry point of the function is restored before control is returned to the executable.

In another embodiment, name matching is used to identify linkage stubs. For example, if it is known that foo_( ) points to foo( ), then the code executable code can be searched for calls to foo_( ) made via IP-relative branch instructions or indirect branches via PLTs. It will be appreciated that the names of linkage stubs are provided as input to the optimization process based on a user's analysis of the source code.

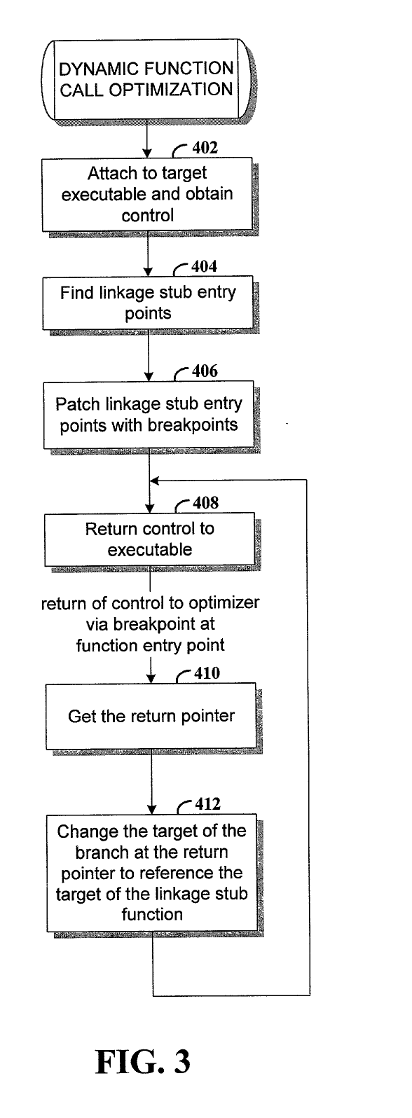

FIG. 3 is a flowchart of a process for eliminating linkage stubs in accordance with another embodiment of the invention. The process of FIG. 3 generally places breakpoints at the entry points of stub linkage functions and upon encountering a breakpoint, replaces the target of the branch instruction that led to the linkage stub function.

At step 402, the optimizer process attaches to the target executable as described in the process of FIG. 2. At step 404, the process finds the entry points of the linkage stubs. In one embodiment, for example, symbolic names of the linkage stubs are provided as input to the optimizer process (e.g., foo_ and _foo). In another embodiment, the names of the functions targeted by the linkage stubs are input to the optimizer (e.g., foo), and the optimizer searches for linkage stubs having names derived from the input name. The addresses of the linkage stub functions are available in either the symbol table or the PLT. At step 406, the linkage stub entry points are patched with breakpoints, and step 408 returns control to the executable program.

When a breakpoint is encountered at the entry point of a linkage stub function, control is returned to the optimizer and step 410. At step 410, the value of the return pointer is obtained to determine the location from which the linkage stub function was called. In addition, the address of the function targeted by the linkage stub function is obtained from code within the stub function. The value of the return pointer is then used, at step 412, to update the target address of the branch instruction that led to the entry point of the linkage stub function. The branch instruction at the address indicated by the return pointer is updated with a target address that references the function targeted by the linkage stub function. After the branch instruction is updated, the process returns control to the executable at step 408.

In yet another embodiment, a static analysis is used to identify the linkage stub functions. The executable program code is read, calls to stub functions (foo_( )) are identified and modified, and the modified executable is written back to a new executable that contains modified branch instructions. If the original executable is a shared, bound executable, the calls to foo_ via the PLT are modified to load the PLT entry for foo instead.

In addition to the example embodiments described above, other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for optimizing an executable program having a plurality of functions and at least one function with a first name associated with executable code that implements the function at a first address and at least one linkage stub code segment having code that branches to the first address and a symbolic name by which the function is invoked in the program, comprising:
identifying branch instructions having target addresses that reference the linkage stub code segment; and
replacing the target addresses of the branch instructions with the first address.

2. The method of claim 1, further comprising replacing the target address of the branch instructions with the first address only in functions that are reached during program execution.

3. The method of claim 1, further comprising:
searching a symbol table for an entry having a symbolic name that that is a derivation of the first name and reading a linkage stub address associated with the symbolic name; and
replacing target addresses of branch instructions having target addresses equal to the linkage stub address with an address at which the code that implements the function is stored.

4. The method of claim 1, further comprising:
searching a symbol table for an entry having a symbolic name that matches the first name with an underscore prefix and reading a linkage stub address associated with the symbolic name; and
replacing target addresses of branch instructions having target addresses equal to the linkage stub address with an address at which the code that implements the function is stored.

5. The method of claim 1, further comprising:
searching a symbol table for an entry having a symbolic name that matches the first name with an underscore suffix and reading a linkage stub address associated with the symbolic name; and
replacing target addresses of branch instructions having target addresses equal to the linkage stub address with an address at which the code that implements the function is stored.

6. The method of claim 1, further comprising:
replacing function entry points in the executable program with breakpoints, whereby breakpointed functions are generated; and
upon encountering a breakpoint of a breakpointed function during program execution, identifying within the breakpointed function branch instructions that target linkage stub functions.

7. The method of claim 6, further comprising:
storing original instructions from the function entry points prior to replacement with the breakpoints;
upon encountering a breakpoint of a breakpointed function during program execution, restoring the original instruction to the entry point of the breakpointed function.

8. The method of claim 6, further comprising:
searching a symbol table for an entry having a symbolic name that that is a derivation of the first name and reading a linkage stub address associated with the symbolic name; and
replacing target addresses of branch instructions having target addresses equal to the linkage stub address with an address at which the code that implements the function is stored.

9. The method of claim 6, further comprising:
searching a symbol table for an entry having a symbolic name that matches the first name with an underscore prefix and reading a linkage stub address associated with the symbolic name; and
replacing target addresses of branch instructions having target addresses equal to the linkage stub address with an address at which the code that implements the function is stored.

10. The method of claim 6, further comprising:
searching a symbol table for an entry having a symbolic name that matches the first name with an underscore suffix and reading a linkage stub address associated with the symbolic name; and
replacing target addresses of branch instructions having target addresses equal to the linkage stub address with an address at which the code that implements the function is stored.

11. The method of claim 1, further comprising:
replacing entry points of linkage stub code segments in the executable program with breakpoints, whereby breakpointed linkage stubs are generated; and
upon encountering a breakpoint of a breakpointed linkage stub during program execution, changing a target address of a branch instruction that branched to the breakpointed linkage stub to reference the function referenced by the breakpointed linkage stub.

12. The method of claim 11, further comprising:
searching a symbol table for an entry having a symbolic name that that is a derivation of the first name and reading a linkage stub address associated with the symbolic name; and
replacing target addresses of branch instructions having target addresses equal to the linkage stub address with an address at which the code that implements the function is stored.

13. The method of claim 11, further comprising:
searching a symbol table for an entry having a symbolic name that matches the first name with an underscore prefix and reading a linkage stub address associated with the symbolic name; and
replacing target addresses of branch instructions having target addresses equal to the linkage stub address with an address at which the code that implements the function is stored.

14. The method of claim 11, further comprising:
searching a symbol table for an entry having a symbolic name that matches the first name with an underscore suffix and reading a linkage stub address associated with the symbolic name; and
replacing target addresses of branch instructions having target addresses equal to the linkage stub address with an address at which the code that implements the function is stored.

15. An apparatus for optimizing an executable program having a plurality of functions and at least one function with a first name associated with executable code that implements the function at a first address and at least one linkage stub code segment having code that branches to the first address and a symbolic name by which the function is invoked in the program, comprising:
means for identifying branch instructions having target addresses that reference the linkage stub code segment; and
means for replacing the target addresses of the branch instructions with the first address.
